(19) United States
(12) Patent Application Publication
(10) Pub. No.: US 2006/0176153 A1
(43) Pub. Date: Aug. 10, 2006

(54) RF transponder with electromechanical power

(76) Inventor: Wai-Cheung Tang, Mannheim (CA)

Correspondence Address: HANLEY, FLIGHT & ZIMMERMAN, LLC, 20 N. WACKER DRIVE, SUITE 4220, CHICAGO, IL, 60606, US

(21) Appl. No.: 11/054,520

(22) Filed: Feb. 9, 2005

(51) Int. Cl. H04Q 5/22

(52) U.S. Cl. 340/10.4; 340/928; 455/343.1; 340/5.61

(57) ABSTRACT

A transponder for use in a vehicular RF communications system, such as an electronic toll collection system or the like. The transponder includes an electromechanical generator for converting the kinetic energy of the vehicle into electrical energy for powering the control electronics and/or RF transceiver electronics of the transponder. The electromechanical generator may charge an energy storage element, such as capacitor or a battery, which is then used as a power source by the transponder electronics. The electromechanical generator may be implemented using microelectromechanical system (MEMS) technology. In one embodiment, the MEMS generator is an inductive microelectromechanical generator including a permanent magnet, a spring, and an electrical coil. In another embodiment, the MEMS generator is a capacitive microelectromechanical generator including a mechanical variable capacitor, switches and control electronics.

### FIELD OF THE INVENTION

The present invention relates to radio frequency identification (RFID) transponders, electronic toll collection and, in particular, to transponders having an electromechanical power source.

### BACKGROUND OF THE INVENTION

RF-based mobile communications systems used in association with vehicles are now commonplace. Such systems are used in a variety of applications, including Automatic Vehicle Identification (AVI) for Commercial Vehicle Operations (CVO) and for Electronic Toll and Traffic Management (ETTM). The systems may also be used in other contexts, including automated payment at drive-through lanes for fast food outlets, automated payment at parking facilities, and automated payment at fueling stations. ETTM systems, for example, allow drivers to pay highway tolls without stopping, allowing a toll station to process a higher volume of traffic.

These systems typically provide for two-way communication between a reader and a transponder (or “tag”). The reader is usually at a fixed point, such as a toll plaza, and the transponder is usually mounted to a vehicle. The transponder stores information of interest to the transaction, including the identity of-the vehicle, time, vehicle type, etc. In some systems, the transponder also stores payment-information, which may include pre-paid account identity, account balance details, credit card information, or other financial data. The reader and the transponder communication using RF signals. These systems typically provide both “read” and “write” capabilities, permitting a reader to access the information stored in the transponder and permitting the transponder to update its stored data in response to instructions from the reader. For example, the reader at a toll plaza may receive and read the transponder information regarding the vehicle type, the most recent toll plaza or on-ramp used by the transponder, and the user's account details. It may then calculate a toll to be paid and transmit instructions to the transponder causing the transponder to debit the account balance stored in its local memory.

Transponders are typically one of two types: active transponders or passive transponders. In active systems, the transponder includes an active transmitter which responds to interrogation or trigger signals from the reader with an active modulated RF response signal generated by the transponder. A passive transponder receives a continuous wave (CW) RF signal from the reader and it communicates using modulated backscatter, i.e. electrically switching the transponder's antenna from a reflective to an absorptive characteristic according to the transponder's modulating signal.

A drawback of active transponders is that they require a power source to generate a response signal and to supply power to the control electronics and any memory elements. Accordingly, active transponders typically have one or more batteries. This necessarily introduces a tension in active transponder design between minimizing the size and expense of the transponder and extending the operating life of the transponder.

Some passive transponders obtain power directly from the reader. Such a transponder receives the CW RF signal from the reader, rectifies it, and uses the rectified RF to operate the device by modulating the backscattered CW signal. The drawback of this approach is that the transponder may only operate while it is under the influence of the RF field from the reader. This limits the effectiveness of passive transponders in free-flow traffic communications since a vehicle spends a very small amount of time in the reader communication range. This is particularly true if the operation of the system requires information to be written into the transponder while the transponder is moving at highway speed. Transponders typically use an EEPROM as non-volatile memory for storing transponder information; however, writing data to existing EEPROMs is a slow operation. The writing operation is too slow to be conducted within a communication zone when the transponder is moving at highway speed. With active devices, the transponder may include a fast temporary memory for holding the transponder data in order to facilitate a transaction with the reader at high speed and the transponder later transfers the data from the temporary memory to the EEPROM. With a passive device, this technique does not work because the device lacks any power to operate once it is outside the communication zone.

It would be advantageous to provide for a transponder that, in part, addresses some of the shortcoming of existing active and/or passive transponders.

### SUMMARY OF THE INVENTION

The present invention provides a transponder for use in a vehicular RF communications system, such as an electronic toll collection system or the like. The transponder includes an electromechanical generator for converting the kinetic energy of the vehicle into electrical energy for powering the control electronics and/or RF transceiver electronics of the transponder. The electromechanical generator may charge an energy storage element, such as capacitor or a battery, which is then used as a power source by the transponder electronics. The electromechanical generator may be implemented using microelectromechanical system (MEMS) technology. In one embodiment, the MEMS generator is an inductive microelectromechanical generator including a permanent magnet, a spring, and an electrical coil. In another embodiment, the MEMS generator is a capacitive microelectromechanical generator including a mechanical variable capacitor, switches and control electronics.

In one aspect, the present invention provides a transponder for use in a vehicle as part of an RF-based electronic payment system, the system including a reader for engaging in RF communications With the transponder. The transponder includes an antenna and an RF module coupled to the antenna for receiving RF interrogation signals from the reader and for transmitting RF response signals to the reader. The transponder also includes a power circuit for supplying power to the RF module, wherein the power circuit includes an electromechanical generator for converting the kinetic energy of the vehicle into electrical energy.

In another aspect, the present invention provides an electronic toll collection system including a plurality of roadside readers for engaging in RF communications with a plurality of vehicle-borne transponders. Each of the transponders includes an antenna and an RF module coupled to the antenna for receiving RF interrogation signals from one of the readers and for transmitting RF response signals to the one of the readers. Each transponder also includes a power circuit for supplying power to the RF module, wherein the power circuit includes an electromechanical generator for converting the kinetic energy of the vehicle into electrical energy.

In yet another aspect, the present application discloses a transponder for use in a vehicle as part of an RF-based electronic payment system, the system including a reader for engaging in RF communications with the transponder. The transponder includes antenna means for receiving RF signals from the reader and transmitting RF signals to the reader, memory means for storing transponder information, and communication means for demodulating a received RF signal and generating a modulated signal containing the transponder information. The transponder also includes means for converting kinetic energy of the vehicle into electrical energy and means for supplying the electrical energy to the communication means.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows a communication zone within an electronic toll collection system;

FIG. 2 shows a block diagram of an embodiment of a transponder having a power circuit containing an electromechanical generator;

FIG. 3 shows a perspective view of an embodiment of an inductive microelectromechanical generator;

FIG. 4 shows a cross-sectional view of the microelectromechanical generator from FIG. 3, taken along an axial line;

FIG. 5 shows a simplified circuit diagram for a capacitive microelectromechanical generator; and

FIGS. 6(a) and 6(b) diagrammatically show microelectromechanical variable capacitors.

Similar reference numerals are used in different figures to denote similar components.

### DESCRIPTION OF SPECIFIC EMBODIMENTS

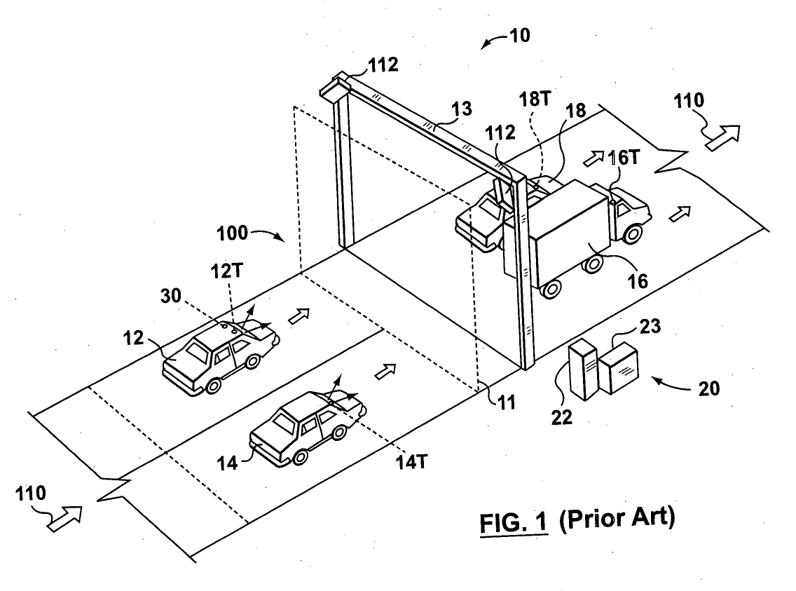

Reference is first made to FIG. 1, which shows a communication zone 100 within an electronic toll collection system 10. The communication zone 100 features a downstream direction indicated by arrows 110. At a point which corresponds to an entrance or an exit point from the highway, tolling equipment is provided comprising a photography gantry 11 and, just downstream therefrom, a radio frequency (RF) toll gantry 13 with antennae 112 thereon. The electronic toll collection system 10 is an “open-road” or “free-flow” type, wherein vehicles are not required to stop, as opposed to a toll-booth or gated-type toll collection system, although the present application is not limited to any particular type of toll collection system.

Motor vehicles 12 and 14 are shown approaching the gantries 11, 13 and motor vehicles 16 and 18 are shown having just passed the gantries 11, 13.

A roadside RF system 20 includes a processor 23 which includes the means for coordinating a reader 22, Application Processing (not shown), Angle of Arrival Processor (not shown), their interfaces and data links. The reader 22 communicates with motor vehicle-borne transponders by means of the gantry antennae 112. Such motor vehicle-borne transponders are shown as 12T, 14T, 16T, and 18T.

The protocol for communication between said transponders 12T, 14T, 16T, and 18T and the reader 22 is a two-way RF communications system, forming part of the electronic toll collection system 10. The RF signals used are normally about 915 MHz, 2.4 GHz and 5.8 GHz

The roadside RF system 20 and the RF toll gantry 13 output a wakeup (or trigger) signal which will activate a transponder circuit within the communications zone 100. The reader 22 continuously polls for transponders that have not previously communicated or have just entered the zone 100. Other embodiments of an electronic toll highway system will be apparent to those of ordinary skill in the art.

The communication protocol will customarily cause the transponders 12T, 14T, 16T, and 18T to communicate specific data carried in memory. The data includes characteristics, such as the transponder identification code, class type (e.g. standard, commercial, recreational), last entry/exit point and, in some applications, account status or balance and battery condition.

The transponders 12T, 14T, 16T, and 18T are, in one embodiment, active transponders, each having their own battery or other storage element for supplying power to the transponders. In this embodiment, the roadside RF system 20 causes the gantry 13 to output a wakeup or trigger signal. After receiving the wakeup or trigger signal a transponder in the communications zone 100, such as transponder 12T, sends a response signal. It will be appreciated that the active transponder depends upon having a sufficient charge stored in its battery to operate correctly.

In another embodiment, the transponders 12T, 14T, 16T, and 18T are passive transponders and the roadside RF system 20 causes the gantry to output a continuous wave RF transmission. A transponder in the communications zone 100, like transponder 12T, receives the continuous wave RF transmission and uses the received energy of the continuous wave RF transmission to power the transponder 12T electronics. Once a sufficient RF field strength is available from the continuous wave RF transmission, the transponder 12T modulates the RF transmission using backscatter modulation to communicate its response signal to the roadside RF system 20. At some point in the transaction, the transponder 12T may need to write information to its memory, which is typically an EEPROM. A writing operation to an EEPROMs occurs at a relatively slow speed, usually too slow to be completed while the transponder 12T remains in the communication zone and is powered by the RF field strength. For these reasons, batteryless passive transponders are less efficient for open-road electronic toll collection than active transponders especially if the ETC system requires information to be written into the transponder while the vehicle is moving at highway speed.

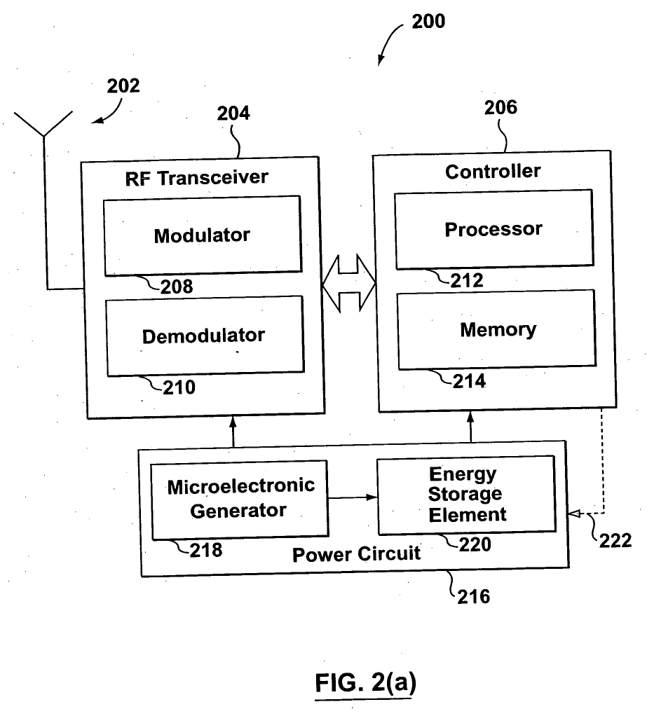

Reference is now made to FIGS. 2(a), (b) and (c), which show block diagrams of embodiments of a transponder 200 in accordance with the present invention.

Referring first to FIG. 2(a), in this embodiment the transponder 200 comprises an active transponder. The transponder 200 includes an antenna 202 coupled to an RF transceiver 204. The transponder 200 also includes a controller 206.

The RF transceiver 204 receives incoming RF signals from the antenna 202 and excites the antenna 202 to generate an outgoing RF transmission. The RF transceiver 204 includes a receiver 210 for demodulating an incoming RF signal to produce a baseband signal. The RF transceiver 204 also includes a transmitter 208 for generating a modulated signal for transmission by the antenna 202. The RF transceiver 204 may include additional elements, including signal shaping components, filters, signal conditioning elements, and other components as will be understood by those of ordinary skill in the art. The RF transceiver 204 outputs a baseband demodulated signal to the controller 206. It receives a data signal from the controller 206 for use by the transmitter 208 in creating the modulated signal.

The controller 206 includes a processor 212 and memory 214. The memory 214 contains transponder data, including the transponder ID. Other information that may be stored as transponder data includes the last reader ID, the last transaction time, and vehicle type or class information. The transponder 200 communicates the transponder data to the roadside RF system 20 (FIG. 1) in response to receipt of an interrogation or trigger signal from the roadside RF system 20. The controller 206 may comprise one or more logic devices, including, for example, a microcontroller or an application specific integrated circuit (ASIC), and is suitably programmed to control the RF transceiver 204 and to receive and generate communications in accordance with a pre-defined communications protocol.

Referring now to FIG. 2(b), in this embodiment the transponder 200 comprises a passive transponder. The transponder 200 includes a receiver/antenna modulator 224 coupled to the antenna 202. One embodiment of the receiver/antenna modulator 224 is shown in greater detail in FIG. 2(c). The receiver/antenna modulator 224 may include a switch 226 for switching the antenna 202 between ground and a predetermined impedance 228. The switch 226 operates in response to a switch signal received from the controller 206. The switch 226 modulates the backscatter signal transmitted by the antenna 202.

Reference is now made to FIGS. 2(a), (b), and (c). The transponder 200 also includes a power circuit 216. The power circuit 216 supplies power to the controller 206 to enable the controller 206 to operate. In the active transponder embodiment shown in FIG. 2(a), the power circuit 216 also supplies power to the RF transceiver 204 to enable it to generate the modulated signal for transmission to a remote reader. In a passive embodiment, the power circuit 216 may receive a charge from the RF transceiver 204, which is supplied via the antenna 202 and the rectification of an induced signal from a continuous wave RF transmission from a remote reader.

The power circuit 216 includes an electromechanical generator 218 for generating electrical energy from the kinetic movement of the transponder 200. In particular, the electromechanical generator 218 generates electrical energy from the vibratory movements of a vehicle in which the transponder 200 is located. All motor vehicles vibrate to some degree when the engine is on and, especially, when the vehicle is in motion. The electromechanical generator 218 converts this kinetic energy into electrical energy.

The electrical energy generated by the electromechanical generator 218 may, in one embodiment, be directly supplied to the controller 206 and/or the RF transceiver 204. The electrical energy may be subjected to certain conditioning and filtering. In another embodiment, the electrical energy generated by the electromechanical generator 218 may be used to charge an energy storage element 220. The energy storage element 220 may comprise a battery, one or more capacitors, or other devices or circuits for storing electrical energy. In some embodiments, the energy storage element 220 may include a base charge or potential, which is supplemented or recharged by the electromechanical generator 218. In other words, in some embodiments, the electromechanical generator 218 may be the sole source of energy for the transponder 200 and, in other embodiments, the electromechanical generator 218 may supplement more traditional sources of energy, in either passive or active implementations. The controller 206 may generate a power circuit control signal 222 which it outputs to control operation of the power circuit 216.

Transponders in the electronic toll collection industry, and in many (if not most) other industries, are typically designed to be compact. Accordingly, the electromechanical generator 218 may be implemented as a microelectromechanical generator using microelectromechanical systems (MEMS) technology. The microelectromechanical generator 218 may generate electrical energy from kinetic energy through inductive or capacitive principles. An appropriate level of energy is obtained from the microelectromechanical generator to power the transponder 200 by micromachining the components to have appropriate resonant properties so as to provide for a reasonably efficient conversion from kinetic energy to electrical energy.

In an active embodiment, the transponder 200 enables longer shelf life, since the electromechanical generator 218 does not have the shelf-life limitations of chemical power supplies, like batteries. The electromechanical generator 218 may be employed to recharge the conventional energy storage element 200 in an active transponder so as to extend its active lifespan.

In a batteryless passive embodiment, the energy supplied by the electromechanical generator 218 may replace or supplement the energy obtained by the transponder 200 from rectification of the continuous wave RF transmission. This may reduce the time the transponder 200 must spend in range of a reader in order to write information into its memory. This, in turn, may improve the efficiency of using batteryless passive transponder with open road toll systems, where historically batteryless passive transponders are inefficient due to their need to be in range of the reader in order to operate. It may also enable passive transponders to perform write functions that have historically proven difficult with open toll road at highway speed due to the lack of on-board power. Lastly, the inclusion of the electromechanical generator 218 may also allow for the use of mobile readers for traffic management and law enforcement by removing the need of overhead gantry typically needed by the batteryless transponder when operated in a high speed environment.

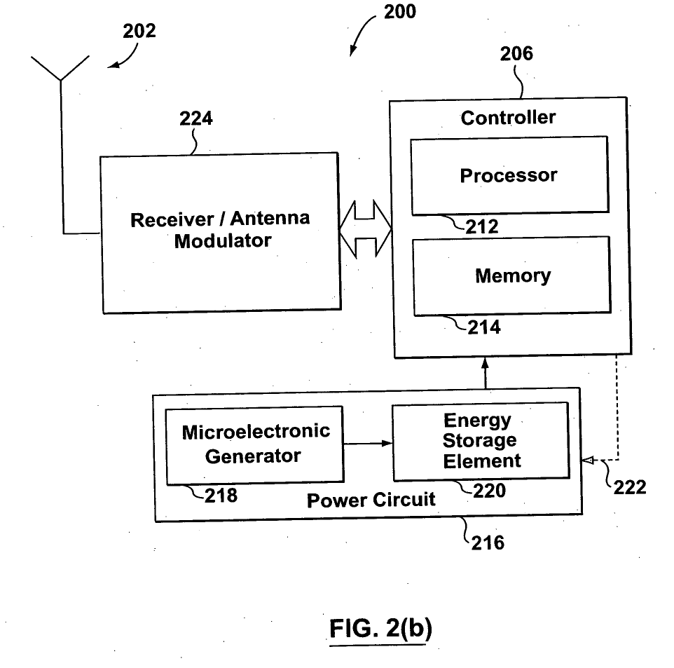

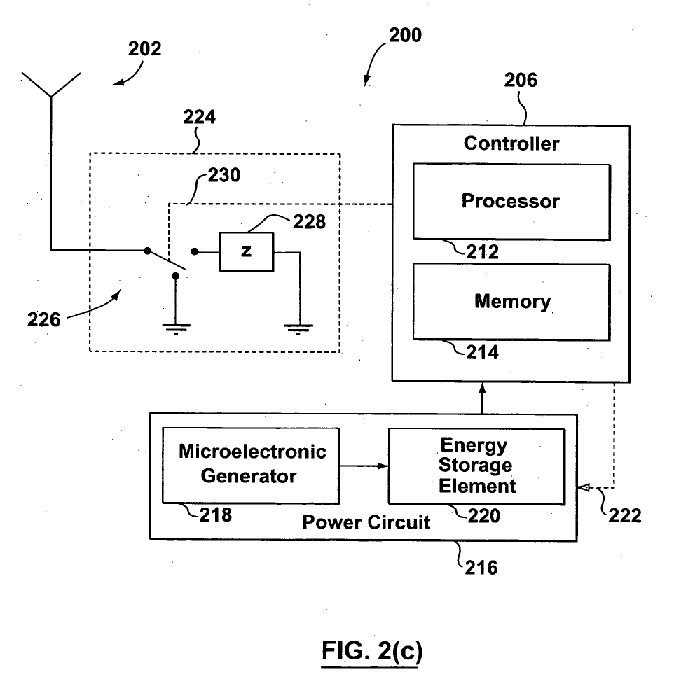

Reference is now made to FIGS. 3 and 4. FIG. 3 shows a perspective view of an embodiment of an inductive microelectromechanical generator 300. FIG. 4 shows a cross-sectional view of the microelectromechanical generator 300 taken along an axial line.

The microelectromechanical generator 300 comprises a permanent magnet 302 supported by a spring 304 inside an electrical coil 306 of wire. The magnet 302 and spring 304 form a mass-spring resonator structure. When the structure is vibrated, the magnet 302 moves relative to the electrical coil 306, thereby varying the magnetic flux passing through the coil 306 and inducing a voltage in the coil 306. The magnet 302 may be a rare-earth magnet. In one embodiment, the magnet 302 comprises a rare-earth Nd—Fe—B magnet.

The spring 304 may be fabricated using any suitable material having the requisite properties in terms of stress, fatigue, and Young's modulus. In some embodiments, the appropriate materials may include silicon, copper, titanium, and/or various alloys, such as the nickel-titanium alloy 55-Ni-45-Ti.

Although the spring 304 shown in FIG. 3 and 4 is a circular spiral pattern, other patterns may be used, including for example a zig-zig pattern, a rectangular spiral patterns, and/or elliptical spiral patterns.

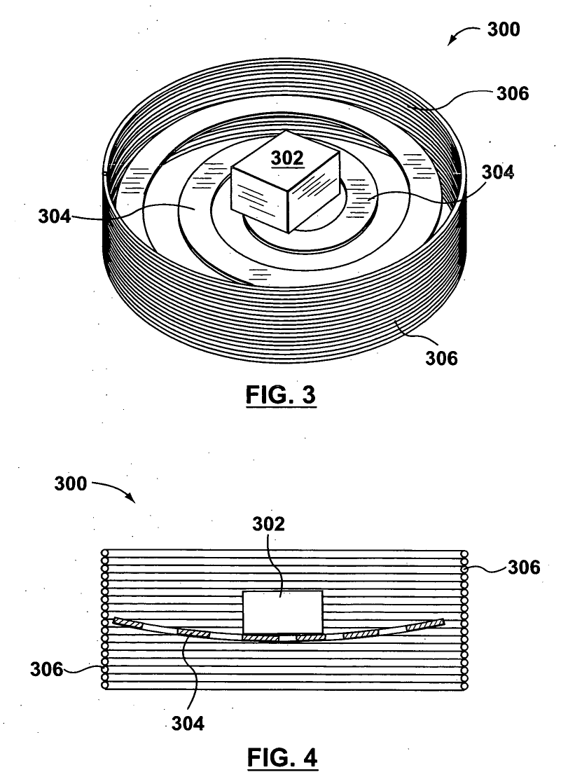

Reference is now made to FIG. 5, which shows a simplified circuit diagram for a capacitive microelectromechanical generator 400.

The capacitive microelectromechanical generator 400 includes a variable capacitor 402, wherein the variable capacitor 402 incorporates a resonant mechanical system. Kinetic energy supplied by the surrounding environment causes the resonant mechanical system to vibrate, altering the geometry of the variable capacitor 402. The geometric changes produce corresponding changes in the capacitance of the variable capacitor 402, and thus, the energy stored in the variable capacitor 402. With appropriate timing, electrical energy introduced mechanically into the system may be extracted and stored in an energy storage element.

The energy conversion may be based upon a charge-constrained cycle or a voltage-constrained cycle. In the charge-constrained cycle, the variable capacitor 402 is initially uncharged and a low voltage is applied across it. The charge on the variable capacitor 402 grows and the variable capacitor 402 is then electrically isolated to constrain its charge level. The variable capacitance is then lowered as a result of the mechanical changes to the system. This results in a corresponding increase in the voltage, increasing the energy content in the variable capacitor 402. When capacitance is at its minimum, energy is extracted. The circuit shown in FIG. 5 is intended for use in a charge-constrained cycle.

In a voltage-constrained cycle the variable capacitor 402 is initially charged to a high voltage when at a maximum capacitance. It is then held at the same voltage as its plates move apart, generating energy to be extracted.

Although the present application describes the implementation of a charge-constrained cycle, it will be appreciated that other cycles, including a voltage-constrained cycle, may be used.

Referring still to FIG. 5, the variable capacitor 402 is connected to an energy storage capacitor 404 and a pair of MOSFETs 406, 408. An inductor 410 is connected across the node between the MOSFETs 406, 408 and the node between the capacitors 402, 406. Control electronics 412 control the timing of the switching by the MOSFETs 406, 408. It will be appreciated that various elements of the circuit may be implemented using discrete devices and/or integrated circuit devices.

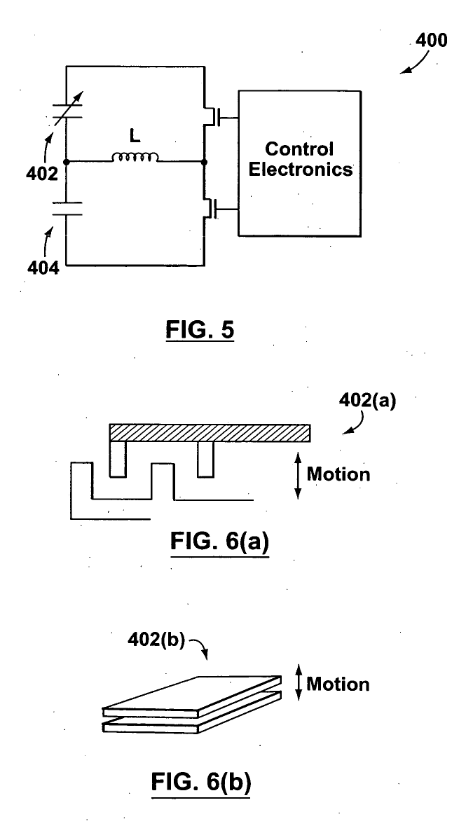

Reference is now made to FIGS. 6(a) and 6(b), which diagrammatically show microelectromechanical variable capacitors 402 (shown individually as 402(a) and 402(b)). FIG. 6(a) depicts a constant-gap microelectromechanical variable capacitor 402(a). FIG. 6(b) depicts a variable-gap microelectromechanical variable capacitor 402(b).

Having regard to the foregoing description, those of ordinary skill in the art will appreciate the range of MEMS devices that may be employed as microelectromechanical generators for converting kinetic energy into electrical energy.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

1. A transponder for use in a vehicle as part of an RF-based electronic payment system, the system including a reader for engaging in RF communications with the transponder, the transponder comprising:
an antenna;
an RF module coupled to said antenna for receiving RF interrogation signals from the reader and for transmitting RF response signals to the reader;
a power circuit for supplying power to said RF module, wherein said power circuit includes a microelectromechanical generator for converting the kinetic energy of the vehicle into electrical energy.

2. (canceled)

3. The transponder claimed in claim 1, wherein said microelectromechanical generator comprises a resonant mass-spring system.

4. The transponder claimed in claim 3, wherein said microelectromechanical generator comprises an inductive microelectromechanical device.

5. The transponder claimed in claim 3, wherein said microelectromechanical generator comprises a capacitive microelectromechanical device.

6. The transponder claimed in claim 5, wherein said capacitive microelectromechanical device operates in accordance with a voltage-constrained cycle.

7. The transponder claimed in claim 5, wherein said capacitive microelectromechanical device operates in accordance with a charge-constrained cycle.

8. The transponder claimed in claim 1, wherein said power circuit includes an energy storage element for supplying power to said RF module, and wherein said microelectromechanical generator charges said energy storage element.

9. The transponder claimed in claim 1, wherein said RF module includes an RF transceiver and a controller.

10. The transponder claimed in claim 1, wherein said RF module employs backscatter modulation.

11. The transponder claimed in claim 1, wherein said RF module employs active RF transmission.

12. An electronic toll collection system including a plurality of roadside readers for engaging in RF communications with a plurality of vehicle-borne transponders, said transponders each comprising:
an antenna;
an RF module coupled to said antenna for receiving RF interrogation signals from one of the readers and for transmitting RF response signals to the one of the readers;
a power circuit for supplying power to said RF module, wherein said power circuit includes a microelectromechanical generator for converting the kinetic energy of the vehicle into electrical energy.

13. (canceled)

14. The electronic toll collection system claimed in claim 12, wherein said microelectromechanical generator comprises a resonant mass-spring system.

15. The electronic toll collection system claimed in claim 14, wherein said microelectromechanical generator comprises an inductive microelectromechanical device.

16. The electronic toll collection system claimed in claim 14, wherein said microelectromechanical generator comprises a capacitive microelectromechanical device.

17. The electronic toll collection system claimed in claim 16, wherein said capacitive microelectromechanical device operates in accordance with a voltage-constrained cycle.

18. The electronic toll collection system claimed in claim 16, wherein said capacitive microelectromechanical device operates in accordance with a charge-constrained cycle.

19. The electronic toll collection system claimed in claim 12, wherein said power circuit includes an energy storage element for supplying power to said RF module, and wherein said microelectromechanical generator charges said energy storage element.

20. The electronic toll collection system claimed in claim 12, wherein said RF module includes an RF transceiver and a controller.

21. The electronic toll collection system claimed in claim 12, wherein said RF module employs backscatter modulation.

22. The electronic toll collection system claimed in claim 12, wherein said RF module employs active RF transmission.

23. A transponder for use in a vehicle as part of an RF-based electronic payment system, the system including a reader for engaging in RF communications with the transponder, the transponder comprising:
antenna means for receiving RF signals from the reader and transmitting RF signals to the reader;
memory means for storing transponder information;
communication means for demodulating a received RF signal and generating a modulated signal containing said transponder information;
microelectromechanical means for converting kinetic energy of the vehicle into electrical energy; and
means for supplying said electrical energy to said communication means.

24. The transponder claimed in claim 23, wherein said microelectromechanical means for converting includes means for inductively converting said kinetic energy into electrical energy.

25. The transponder claimed in claim 23, wherein said microelectromechanical means for converting includes means for capacitively converting said kinetic energy into electrical energy.

26. The transponder claimed in claim 23, wherein said means for supplying includes means for storing said electrical energy.
